(19) United States
(12) Patent Application Publication
(10) Pub. No.: US 2022/0108405 A1
(43) Pub. Date: Apr. 7, 2022

(54) SYSTEMS AND METHODS FOR MEASURING AND INCENTIVIZING PARTICIPATION AND ACTION ON CIVIC ISSUES VIA AN ONLINE SOCIAL MEDIA PLATFORM

(71) Applicant: Syed RIZVI, Toronto (CA)

(72) Inventor: Syed RIZVI, Toronto (CA)

(21) Appl. No.: 17/495,777

(22) Filed: Oct. 6, 2021

Related U.S. Application Data
(60) Provisional application No. 63/088,407, filed on Oct. 6, 2020.

(51) Int. Cl. G06Q 50/00; G06Q 30/02

(52) U.S. Cl. CPC G06Q 50/01; G06Q 30/0234; G06Q 30/0235

(57) ABSTRACT

A system and method for measuring and incentivizing participation on civic issues is provided, comprising a computer system comprising at least a data processor and a memory. One or more computing devices used by a plurality of users subscribed to the platform. A subsystem configured to cause display of one or more civic issues, published by one or more users, on the one or more commuting devices. A scoring subsystem configured to couple one or more actions to each civic issue, tally actions performed by one or more of the users, award one or more points to the one or more users based on one or more of the action performed, a quantitative and/or qualitative response to the action performed, a quantitative and/or qualitative response to the civic issue. A generated count represented for an individual user from the plurality of users based on an amalgamation of the points awarded.

### FIELD OF THE INVENTION

The present disclosure relates to a system and method for measuring and incentivizing participation and action on civic issues, more specifically but not by way of limitation, a social media platform which applies gamification to facilitate positive social change.

### BACKGROUND

Social networks facilitate connection for users around the world. Although a lot of uplifting stories and messages are continually shared across these social networks, vitriol and negativity still persists throughout which can deter prolonged participation on the social networks. Social networks can also be utilized for spreading awareness on crucial issues and allow users to interact with each other and contribute to positive change with these issues but typically lack an incentive structure and updated progress on how their interactions result in real social change.

U.S. Pub. No. 2016/0343087 A1 (Dange) discloses a method of receiving a post corresponding to a civic issue on an online social network, sorting the posts and updating the current status of the posts. Shortcomings include a lack of incentivization for users to participate in the civic issue.

U.S. Pub. No. 2015/0358390 A1 (Starr et al.) discloses a system and method for sharing social causes with other users on a mobile application. Shortcomings include a lack of incentivization for users to participate in the social cause beyond the potential notoriety of the user appearing on the front page of the application, as well as an inability to track the progress of the social cause after the user's participation.

U.S. Pub. No. 2014/0019259 A1 (Dung et al.) discloses a method and system for promoting charity donations through publicizing a person's contribution, which is based on a combination of money donated and efforts in publicizing the charity's cause in a social network. Shortcomings include an inability to track the progress of the social cause after the user's participation and a lack of incentivization for users to participate in the civic issue through rewards.

U.S. Pub. No. 2009/0012895 A1 (Mehrabi) discloses a method and system for creating and promoting a cause and processing payments for the cause by utilizing social networks. Shortcomings include an inability to track the progress of the social cause after the user's participation and a lack of incentivization for users to participate in the civic issue.

All documents cited herein are incorporated by reference.

There is a need for a system and method for measuring and incentivizing a user's participation and action on civic issues through the application of gamification on an online social media platform to facilitate positive social change amongst individuals and businesses, the ability for the user to track the positive social change resulting from the participation and action on the civic issues, the ability for the user to obtain one or more rewards through the gamification and the ability for the user to obtain notoriety on the online social media platform through the gamification.

### BRIEF SUMMARY

It is the object of the present invention to provide a system and method for measuring and incentivizing participation and action on one or more civic issues via an online social media platform.

In accordance with an aspect of the invention, there is provided a system for measuring and incentivizing participation and action on one or more civic issues via an online social media platform comprising a computer system comprising at least a data processor and a memory. One or more computing devices used by a plurality of users subscribed to the online social media platform. A subsystem configured to cause display of the one or more civic issues, published by one or more of the users, on the one or more commuting devices and a scoring subsystem. The scoring subsystem configured (i) to couple one or more actions to the one or more civic issues, (ii) tally the one or more actions performed by one or more of the users, (iii) award one or more points to the one or more users based on the group consisting of the action performed, a quantitative response to the action performed, a qualitative response to the action performed, a quantitative response to the civic issue published, a qualitative response to the civic issue published, and (iv) generate a count represented for an individual user from the plurality of users based on an amalgamation of the points awarded.

In accordance with an additional aspect of the invention, there is provided a computer implemented method of measuring and incentivizing participation and action on one or more civic issues via an online social media platform by a plurality of users subscribed to the online social media platform, the method comprising receiving, at a computer system comprising at least a data processor and a memory, data relating to one or more civic issues by one or more of the users. Generating a scoring subsystem, the scoring subsystem configured (i) to couple one or more actions to the one or more civic issues, (ii) tally the one or more actions performed by one or more of the users, (iii) award one or more points to the one or more users based on the group consisting of the action performed, a quantitative response to the action performed, a qualitative response to the action performed, a quantitative response to the civic issue published, a qualitative response to the civic issue published, and (iv) generate a count represented for an individual user from the plurality of users based on an amalgamation of the points awarded.

In accordance with an embodiment of the invention, the actions are selected from the group consisting of signing a petition, signing a letter, signing up to volunteer, creating or joining events, donating, sharing, commenting, messaging, fundraising, subscriptions, merchandising, and adoption.

In accordance with an embodiment of the invention, a multiplier is applied to the awarded points.

In accordance with an embodiment of the invention, the multiplier is applied for a set time period.

In accordance with an embodiment of the invention, the count is published on the online social media platform.

In accordance with an embodiment of the invention, the count is only visible to the individual user.

In accordance with an embodiment of the invention, the users are sorted into a plurality of tiers.

In accordance with an embodiment of the invention, the awarded points are redeemed for rewards.

In accordance with an embodiment of the invention, the awarded points are converted to an online currency.

In accordance with an embodiment of the invention, online currency is exchanged for a legal tender.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

A human being's choice and actions are very consequential, as they can have a rippling effect through time. The following online social media platform presented promotes a switch to remove all of the negative stories typically forwarded and shared through most online social media platforms and allows users to view only positive stories along with positive reactions to these stories.

Most importantly, the online social media platform utilizes gamification, referred to as the Positive Ripple Score, to incentive users to participate, reflect on and enact change across a broad range of civic issues and non-civic issues, referred to collectively, hereafter, as “civic issues”. Some examples for the civic issues addressed may include, but are not limited to, religious, technological, cultural, historical and personal.

A system for measuring and incentivizing participation and action on one or more civic issues via an online social media platform is provided comprising, a computer system comprising at least a data processor and a memory, one or more computing devices used by a plurality of users subscribed to the online social media platform, a subsystem configured to cause display of the one or more civic issues, published by one or more of the users, on the one or more commuting devices and a scoring subsystem. The scoring subsystem is configured to couple one or more actions to the one or more civic issues, tally the one or more actions performed by one or more of the users, award one or more points to the one or more users.

A computer implemented method of measuring and incentivizing participation and action on one or more civic issues via an online social media platform by a plurality of users subscribed to said online social media platform is provided. The method comprises receiving, at a computer system comprising at least a data processor and a memory, data relating to one or more civic issues by one or more of the users and generating a scoring subsystem. The scoring subsystem is configured to couple one or more actions to the one or more civic issues, tally the one or more actions performed by one or more of said users, award one or more points to the one or more users, and generating a count represented for an individual user from the plurality of users based on an amalgamation of the points awarded.

Users, such as but not limited to individuals, celebrities or businesses, can sign up to the online social media platform and choose to disclose gender, political view, religion, ethnicity, status such as individual or corporation. Users may present various civic issues or opportunities that are important to them, such as but not limited to, education, poverty, disaster relief, etc.

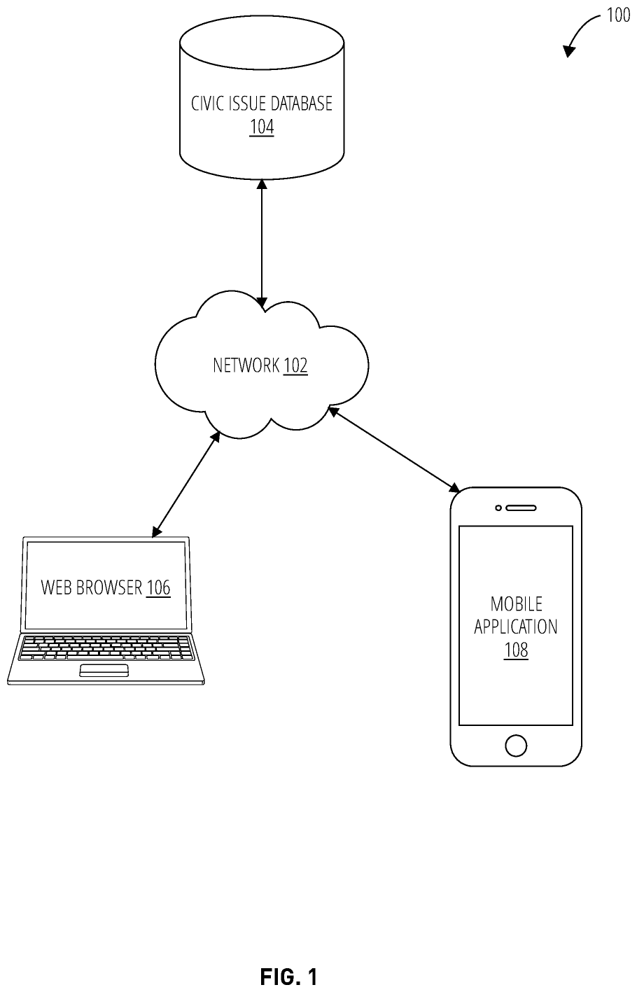

FIG. 1 depicts a high-level system diagram 100 of the online social media platform as in one embodiment. The network 102 shown here facilitates data transfer between the civic issue database 104, web browser 106 and mobile application 108. The civic issue database 104 stores various data structures related to the online social media platform, such as but not limited to, user information and civic issue libraries.

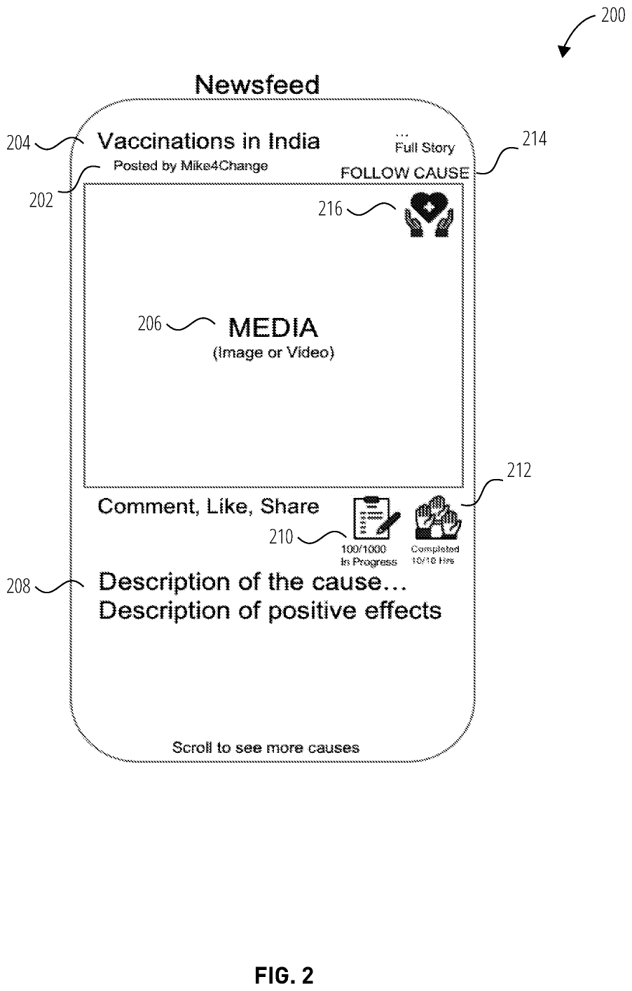

FIG. 2 depicts a newsfeed section 200 of the online social media platform as in one embodiment. In the embodiment shown, a newsfeed is available on the online social media platform for displaying some of the civic issues posted by users on the platform. One or more of the civic issues posted may include some form of media 206, such as but not limited to an image or video, and a description 208 of the civic issue. Updates may be provided in the description 208 as they develop by users or administrators.

The newsfeed section 200 shown includes a follow cause function 214 to enable the user to track the specific civic issue. In some embodiments, the newsfeed section 200 will take into account users' pre-selected civic issue categories 216, such as health in FIG. 2. The pre-selected civic issue categories 216 will impact the specific civic issues 204 shown to the user, such as vaccinations in India in FIG. 2. In some embodiments, the newsfeed section 200 will take into account the specific civic issues 204 a user follows using the follow cause function 214, and display similar causes, even if those civic issues are not in a user's pre-selected civic issue categories 216.

The username 202 of the user who published the civic issue is also visible in this embodiment. In some embodiments, users are able to follow other users to enable users to track their certain civic issues and their impact. In other embodiments, the pre-selected civic issue categories 216 can take into account user history from previously viewed civic issues 204, which can be applied to their newsfeed section 200.

In some embodiments, users will be able to join corporate groups or groups with their online friends to react as a group to civic issues, as well as have teams compete with each other to see who can obtain the most points within a given timeframe as an additional incentive structure.

In this embodiment, the actions which allow the user to engage with and react to the civic issue include commenting, liking, sharing, signing a petition 210 and volunteering 212. In some embodiments, users can also perform actions with predetermined means of communication through emojis or users can create an image to share on the online social media platform. Additionally, some actions may include status information, such as but not limited to, not started, started-incomplete, completed successfully or the user may be able to view the progress towards a pre-set goal, for example 1/100 signatures received or $75/$100 funds raised.

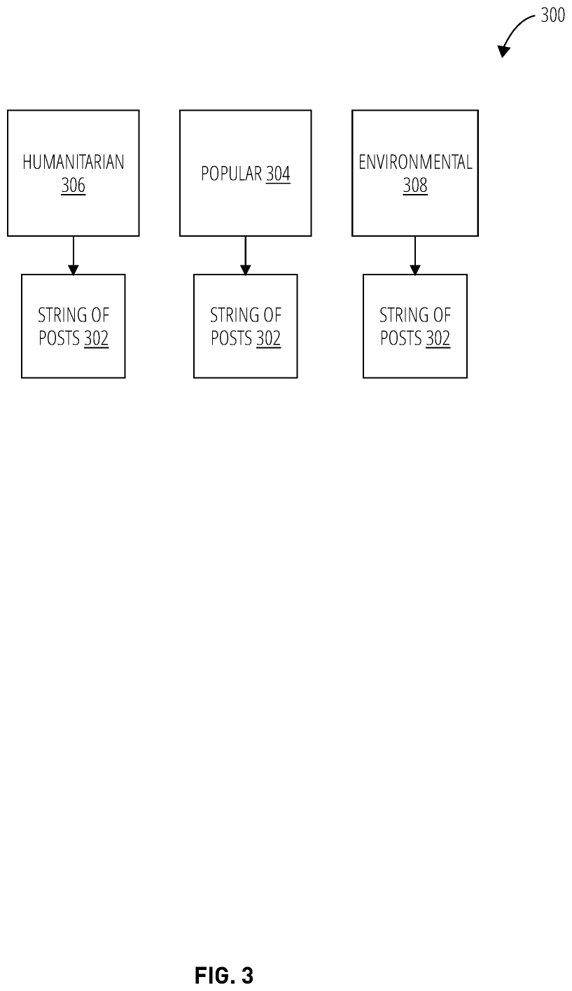

FIG. 3 depicts various civic issue categories 300 of the online social media platform as in one embodiment. The categories may be separated by various subjects such as environmental 308, humanitarian 306, popular 304, as in this example, or other subjects such as but not limited to local or regional, poverty, food and hunger, racial and economic equality, peace, human rights, social justice, covid-19, health and safety, disaster relief, education, animal rights, politics, corporate social responsibility, personal accessibility, child and youth, religion, women's rights, technology, legislation, censorship, democracy and legal causes. Each selected category contains a string of posts 302 which can be sorted based on popularity, the timeline, etc. The user can also set preferences for customizing the categories and the string of posts 302 presented to them.

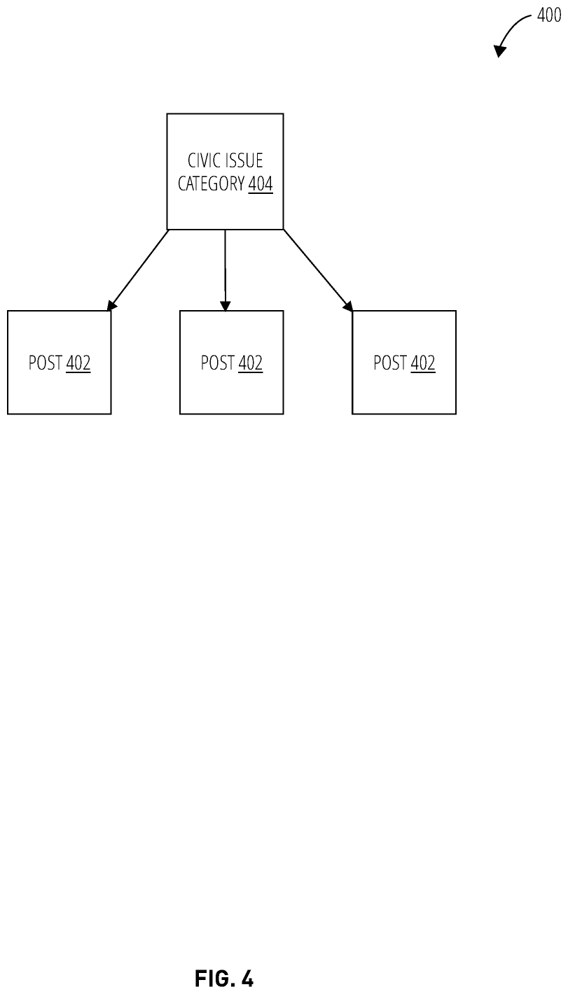

FIG. 4 depicts an overview 400 of a selected category 404 of the online social media platform as in one embodiment. The civic issue category 404 displayed presents 3 posts 402 associated with the category, with each post representing a specific civic issue 204 within the civic issue category 404.

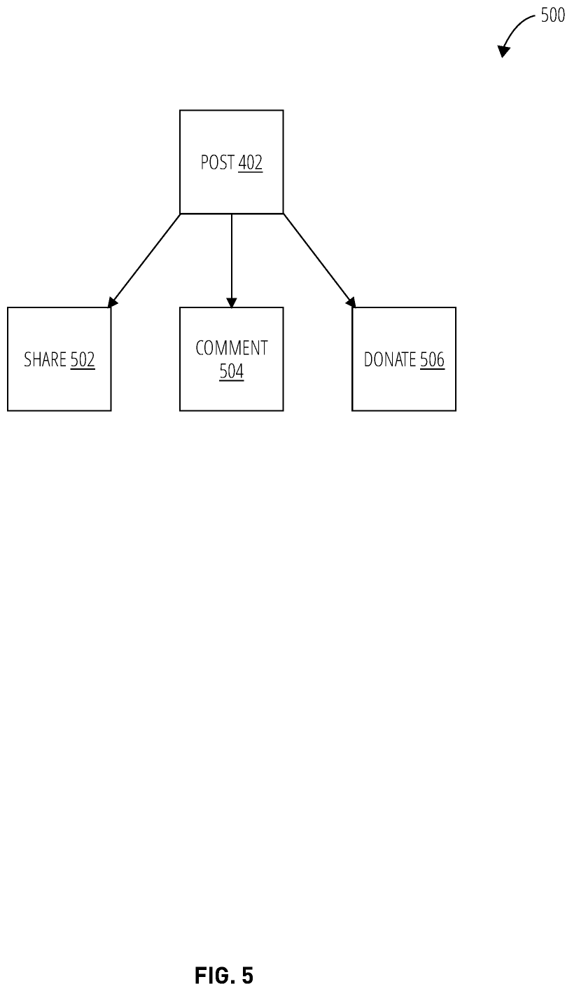

FIG. 5 depicts an overview of the user interactions 500 with a post 402 from the online social media platform as in one embodiment. Some examples of actions available to the users include, but are not limited to, signing a petition 210, signing a letter, signing up to volunteer 212, donate 506 to civic issue, share 502 the post 402 across other social media networks, SMS, text messages, emails and various applications, add a comment 504 to the post 402, fundraising, subscriptions and merchandising. In some embodiments, the subscriptions are paid and involve subscription tiers.

Users on the online social media platform are incentivized to perform one or more of these actions as points are awarded to the user based on the group consisting of the action performed, a quantitative response to the action performed, a qualitative response to the action performed, a quantitative response to the civic issue published, and a qualitative response to the civic issue published. Furthermore, a count is generated and updated for each individual user which represents an amalgamation of the points awarded to the user.

For example, a user can include a petition 210 in a post 402 for users to sign or another user can positively react to a post 402 by creating a petition 210. Creating a petition 210 and joining a petition 210 will result in different values for the awarded points to each user. The petition 210 may vary in the milestones assigned to them, such as a variation in the number of signatures promoted as the goal of the petition. Similarly, the earlier the user is able to join in on a civic issue the better the awarded score that the user achieves from that specific civic issue. The actions may be further ranked by category, contribution to the post 402, as determined by an administrator or analysts, the timeline of contribution to the post 402 or the completion of the post 402. In some embodiments, users can also pay a fee to get their post 402 featured or moved to the top of the newsfeed section 200 for a period of time in a specific category 404.

In some embodiments, a multiplier may be applied to the awarded points which would be normally awarded based on the factors mentioned previously. In some embodiments, the multiplier is applied for a set time period. The multiplier may be referred to as a Blitz, which may be created by an administrator to increase the awarded points beyond their normal value to a specific post, category or action for a specified goal and/or time period. In other embodiments, users may be sorted by a plurality of tiers based on their accumulation of awarded points. In some embodiments, items may be awarded in lieu of or in addition to points. Some examples of the items include, but are not limited to, clothing or concert tickets.

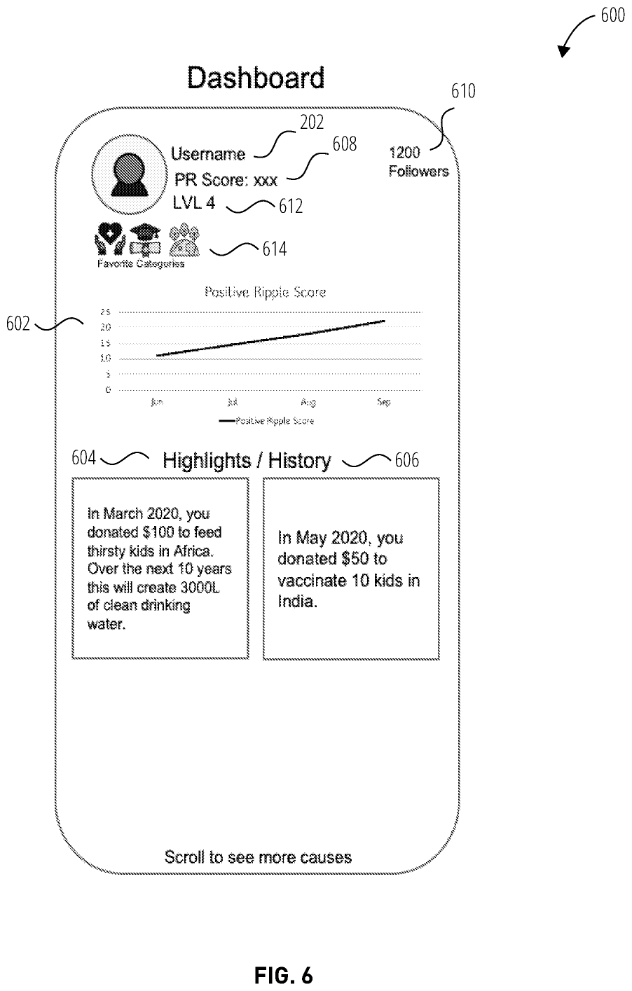

FIG. 6 depicts a dashboard section 600 of the online social media platform as in one embodiment. The users can view their awarded points, also referred to as their positive ripple score 608, over time on a graph in addition to successful outcomes of their actions based on a qualitative assessment of the activities they have contributed in. For example, if a user initially donated ten dollars to a water well, they can receive an update that the well has served six hundred glasses of water as of a specified date thanks in large part to their actions. Forecasts may also be displayed, such as a twenty year projection predicting six thousand glasses of water served based on the initial donation stated previously. In some embodiments, the overall count of the user's awarded points may be set to private where the user can choose to withhold publishing their positive ripple score 608 for other users to view. In other embodiments, the overall count of the user's awarded points may be set to public where the user can choose to publish their positive ripple score 608 for other users to view.

Furthermore, analytics from the user's statistics 602 can be utilized to generate a report of the civic issues and contributions that the user has had on society. This report can be shared with the public via the online social media platform, other social media networks, SMS, text messages, emails and various applications. This report can also be used by the user to reflect on the current impact and future forecast of the impact they have had on the world. In this embodiment, the user's username 202, positive ripple score 608, level 612, favorite categories 614, follower count 610, statistics 602 for the user's positive ripple score 608, history 606 and highlights 604 of the actions and results for every civic issue that the user engaged in are displayed.

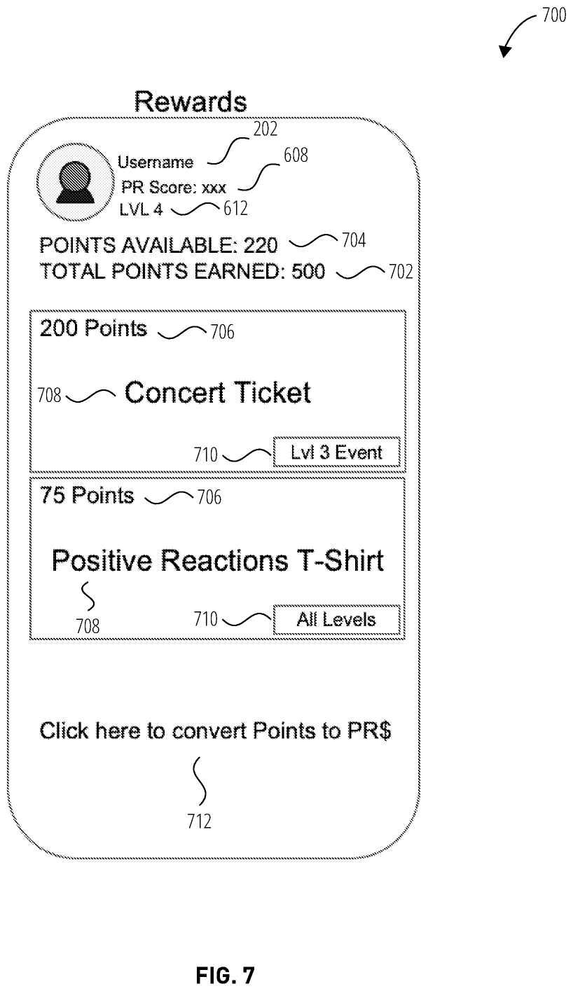

FIG. 7 depicts a rewards sections 700 of the online social media platform as in one embodiment. In this embodiment, the user's username 202, positive ripple score 608, level 612, points available score 704 and total points earned score 702 are displayed. In some embodiments, the total points earned score 702 may represent the total points earned for an action performed or as the result of a qualitative response to an action performed. In other embodiments, the total points earned score 702 and the positive ripple score 608 are synonymous. The points available score 704 provides the user an indication as to what amount of their overall awarded points, their positive ripple score 608, is available to apply to earn one or more of the displayed rewards 708 or for conversion to the online currency, which is achieved in this embodiment through the points conversion function 712. The online currency can be donated to the various civic issues published on the online social media platform and exchanged for a legal tender. In other embodiments, the online currency can be exchanged for an item, such as but not limited to, clothing and concert tickets.

Each reward is displayed with an associated reward cost 706 and the reward 708 available for purchase. In addition to the reward cost 706, FIG. 7 displays a level requirement 710, which maybe also be referred to by a certain tier, that the user is required to meet to be eligible to redeem each reward 708. In some embodiments, the levels 612 are based on the user's frequency of engagement and interactions, or the outcome of actions performed. The level 612 can also impact the points awarded to the user and participation in a Blitz. In other embodiments, users can earn rewards for completing various challenges and for reaching certain positive ripple scores 608.

Generally, all terms used herein are to be interpreted according to their ordinary meaning in the relevant technical field, was a different meaning is clearly given and/or is implied from the context in which it is used. All references to an element, apparatus, component, means, step, etc. are to be interpreted openly as referring to at least one instance of the element, apparatus, component, means, step, etc., unless explicitly stated otherwise the steps of any methods disclosed herein do not have to be performed in the exact order disclosed, unless a step is explicitly described as following or proceeding another step and/or where it is implicit that a step must follow or proceed another step. Any feature of any embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU). Computers suitable for the execution of a computer program include, by way of example, general or special purpose microprocessors or both, or any other kind of central processing unit. Generally, a central processing unit receives instructions and data from a read-only memory or a random-access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive. Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

What is claimed is:

1. A system for measuring and incentivizing participation and action on one or more civic issues via an online social media platform comprising:
a computer system comprising at least a data processor and a memory;
one or more computing devices used by a plurality of users subscribed to said online social media platform;
a subsystem configured to cause display of said one or more civic issues, published by one or more of said users, on said one or more commuting devices; and
a scoring subsystem, said scoring subsystem configured (i) to couple one or more actions to said one or more civic issues; (ii) tally said one or more actions performed by one or more of said users; (iii) award one or more points to said one or more users based on the group consisting of said action performed, a quantitative response to said action performed, a qualitative response to said action performed, a quantitative response to said civic issue published, a qualitative response to said civic issue published; and (iv) generate a count represented for an individual user from said plurality of users based on an amalgamation of said points awarded.

2. The system of claim 1, wherein said actions are selected from the group consisting of signing a petition, signing a letter, signing up to volunteer, creating or joining events, donating, sharing, commenting, messaging, fundraising, subscriptions, merchandising, and adoption.

3. The system of claim 1, wherein a multiplier is applied to said awarded points.

4. The system of claim 3, wherein said multiplier is applied for a set time period.

5. The system of claim 1, wherein said count is published on said online social media platform.

6. The system of claim 1, wherein said count is only visible to said individual user.

7. The system of claim 1, wherein said users are sorted into a plurality of tiers.

8. The system of claim 1, wherein said awarded points are redeemed for rewards.

9. The system of claim 1, wherein said awarded points is converted to an online currency.

10. The system of claim 9, wherein said online currency are exchanged for a legal tender.

11. A computer implemented method of measuring and incentivizing participation and action on one or more civic issues via an online social media platform by a plurality of users subscribed to said online social media platform, the method comprising:
receiving, at a computer system comprising at least a data processor and a memory, data relating to one or more civic issues by one or more of said users; and
generating a scoring subsystem, said scoring subsystem configured
(i) to couple one or more actions to said one or more civic issues;
(ii) tally said one or more actions performed by one or more of said users;
(iii) award one or more points to said one or more users based on the group consisting of said action performed, a quantitative response to said action performed, a qualitative response to said action performed, a quantitative response to said civic issue published, a qualitative response to said civic issue published; and
(iv) generate a count represented for an individual user from said plurality of users based on an amalgamation of said points awarded.

12. The method of claim 11, wherein said actions are selected from the group consisting of signing a petition, signing a letter, signing up to volunteer, creating or joining events, donating, sharing, commenting, messaging, fundraising, subscriptions, merchandising, and adoption.

13. The method of claim 11, wherein a multiplier is applied to said awarded points.

14. The method of claim 13, wherein said multiplier is applied for a set time period.

15. The method of claim 11, wherein said count is published on said online social media platform.

16. The method of claim 11, wherein said count is only visible to said individual user.

17. The method of claim 11, wherein said users are sorted into a plurality of tiers.

18. The method of claim 11, wherein said awarded points are redeemed for rewards.

19. The method of claim 11, wherein said awarded points are converted to an online currency.

20. The method of claim 19, wherein said online currency is exchanged for a legal tender.
